(19) United States
(12) Patent Application Publication
(10) Pub. No.: US 2026/0017697 A1
(43) Pub. Date: Jan. 15, 2026

(54) SYSTEMS AND METHODS FOR GENERATING AGGREGATED REVIEWS

(71) Applicant: Walmart Apollo, LLC, Bentonville, AR (US)

(72) Inventors: Hari Prasad Piridi, Bengaluru (IN); Rahul Ghosh, Bangalore (IN); Himanshu Tanwar, Bengaluru (IN); Anuranjan Kumar, Bangalore (IN); Sunil Rudresh, Bangalore (IN); Dhruv Sharma, G.B. Nagar (IN); Girish Thiruvenkadam, Bangalore (IN)

(21) Appl. No.: 19/231,808

(22) Filed: Jun. 9, 2025

Related U.S. Application Data
(60) Provisional application No. 63/670,645, filed on Jul. 12, 2024.

(51) Int. Cl. G06Q 30/0282

(52) U.S. Cl. CPC G06Q 30/0282

(57) ABSTRACT

Systems and methods for generating aggregate reviews are disclosed. Generating aggregate reviews includes receiving review data associated with an item object in a database and selecting a subset of the review data based on a first selection criteria. The systems and methods further include generating, a target keyword score for each respective target keyword based on a polarity of the target keywords, selecting a subset of the target keywords based on a predetermined range of the target keyword scores, generating one or more target keyword summaries for each respective target keyword, generating an item object summary based on the one or more target keyword summaries, iteratively modifying the item object summary using a self-critique module, and generating a set of instructions to cause the item object summary to be displayed on a user interface.

### CROSS-REFERENCE TO RELATED APPLICATIONS

This application claims priority to Provisional Application No. 63/670,645, filed on Jul. 12, 2024 and entitled “Systems and Methods for Generating Aggregated Reviews,” the contents of which are incorporated herein in their entirety.

### TECHNICAL FIELD

This application relates generally to automated generation of textual data, and more particularly, to automated generation of textual data using iterative improvement.

### BACKGROUND

Network-based interfaces, such as ecommerce interfaces, can include hundreds of items that may be viewed, added-to-cart, purchased, or otherwise interacted with. On some network-based interfaces, individual items can include hundreds of reviews providing ratings and text-based reviews of the corresponding item. When a user is considering an item, they may be subject to cognitive overload and decision-making fatigue from reading through hundreds of reviews in an effort to make a decision regarding one or more similar items. Cognitive overload and/or decision-making fatigue may cause some users to potentially abandon interactions with the item, item page, and/or network interface.

### SUMMARY

In various embodiments, a system is disclosed. The system includes a non-transitory memory having instructions stored thereon and a processor. The processor is configured to read the instructions to receive review data associated with an item object in a database. The review data includes one or more review features including one or more target keywords. The processor is further configured to select a subset of the review data based on a first selection criteria configured to select a first subset of the review data, generate by a target keyword ranking module, a target keyword score for each respective target keyword of the one or more target keywords based on a polarity of the target keywords, select a subset of the target keywords each having a respective target keyword score based on a predetermined range of the target keyword scores, generate one or more target keyword summaries for each respective target keyword of the selected subset of the target keywords, generate an item object summary based on the one or more target keyword summaries using a summarization model, and iteratively modify the item object summary using a self-critique module based on at least one or more characteristics of the item object summary. The self-critique module includes one or more large language models configured to evaluate the at least one or more characteristics of the item object summary and adjust the item object summary in accordance with a determination that the at least one or more characteristics of the item object summary does not meet a first criteria. The processor is further configured to generate a set of instructions to cause the item object summary to be displayed on a user interface.

In various embodiments, a computer implemented method is disclosed. The computer implemented method includes a step of receiving review data associated with an item object in a database. The review data includes one or more review features including one or more target keywords. The method further includes steps of selecting a subset of the review data based on a first selection criteria configured to select high-quality review data, generating, by a target keyword ranking module, a target keyword score for each respective target keyword of the one or more target keywords based on a polarity of the target keywords, selecting a subset of the target keywords each having a respective target keyword score based on a predetermined range of the target keyword scores, generating one or more target keyword summaries for each respective target keyword of the selected subset of the target keywords, generating an item object summary based on the one or more target keyword summaries using a summarization model, and iteratively modifying the item object summary using a self-critique module based on at least one or more characteristics of the item object summary. The self-critique module includes one or more large language models configured to evaluate the at least one or more characteristics of the item object summary and adjust the item object summary in accordance with a determination that the at least one or more characteristics of the item object summary does not meet a first criteria. The method further includes a step of generating a set of instructions to cause the item object summary to be displayed on a user interface.

In various embodiments, a non-transitory computer readable medium having executable instructions stored thereon is disclosed. When the executable instructions are executed by one or more processors of a computing device, the instructions cause the one or more processors to receive review data associated with an item object in a database. The review data includes one or more review features including one or more target keywords. The instructions further cause the processor to select a subset of the review data based on a first selection criteria configured to select high-quality review data, generate, by a target keyword ranking module, a target keyword score for each respective target keyword of the one or more target keywords based on a polarity of the target keywords, select a subset of the target keywords each having a respective target keyword score based on a predetermined range of the target keyword scores, generate one or more target keyword summaries for each respective target keyword of the selected subset of the target keywords, generate an item object summary based on the one or more target keyword summaries using a summarization model, and iteratively modify the item object summary using a self-critique module based on at least one or more characteristics of the item object summary. The self-critique module includes one or more large language models configured to evaluate the at least one or more characteristics of the item object summary and adjust the item object summary in accordance with a determination that the at least one or more characteristics of the item object summary does not meet a first criteria. The instructions further cause the processor to generate a set of instructions to cause the item object summary to be displayed on a user interface.

### BRIEF DESCRIPTION OF THE DRAWINGS

The features and advantages of the present disclosures will be more fully disclosed in, or rendered obvious by, the following detailed description of the preferred embodiments, which are to be considered together with the accompanying drawings wherein like numbers refer to like parts and further wherein:

FIG. 1 illustrates a network environment configured to generate aggregated reviews using automated, self-critiquing generative processes, in accordance with some embodiments;

FIG. 2 illustrates a computer system configured to implement one or more processes, in accordance with some embodiments;

FIG. 3 is a flowchart illustrating a summary generation method configured to generate one or more target keyword summaries and/or an item object summary using automated, self-critiquing generative processes, in accordance with some embodiments;

FIG. 4 is a process flow illustrating various steps of the summary generation method of FIG. 3, in accordance with some embodiments;

FIG. 5 illustrates an example of an item object review summary and a target keyword summary at a user interface, in accordance with some embodiments;

FIG. 6 illustrates one or more equations used by one or more modules during generation of an aggregated review, in accordance with some embodiments;

FIG. 7 illustrates an artificial neural network, in accordance with some embodiments;

FIG. 8 illustrates a deep neural network (DNN), in accordance with some embodiments;

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for generating aggregated reviews. In various embodiments, the generation of aggregated reviews is done by receiving review data, detecting one or more target keywords, generating summaries for each target keyword, and generating an overall summary based on the target summaries. Text-based review data (e.g. written reviews) subjective, quantitative and/or image based (e.g., star rankings, thumbs up, etc.), and/or other review data associated with an item object in a database is received. The review data includes features, such as one or more target keywords. A subset of the review data is selected based on selection criteria. The subset of the review data includes reviews having one or more target keywords. A target keyword ranking module generates a target keyword score for each respective target keyword in the subset of the review data. The target keyword score may be generated based on a polarity of the target keywords. A subset of the target keywords with a respective target keyword score in a predetermined range are identified and summaries are generated for each target keyword in the subset. A summarization tool generates an item object summary based on the one or more target keyword summaries. The item object summary is iteratively modified using a self-critique module based on at least one or more characteristics of the item object summary. The self-critique module includes one or more large language models configured to evaluate the at least one or more characteristics of the item object summary and adjust the item object summary in accordance with a determination that the at least one or more characteristics of the item object summary does not meet a first criteria. The generated summary is displayed via a user interface in conjunction with the corresponding item.

In some embodiments, systems, and methods for generating aggregated reviews includes one or more trained large language learning. The trained large language models may include one or more models, such as the generation of aggregated reviews model.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

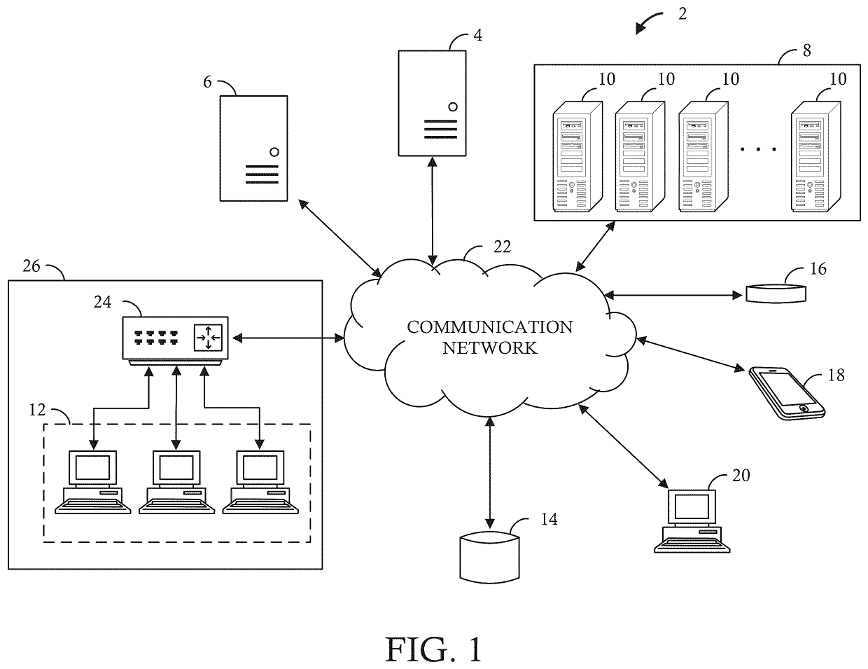

FIG. 1 illustrates a network environment 2 configured to provide the generation of aggregated reviews, in accordance with some embodiments. The network environment 2 includes a plurality of devices or systems configured to communicate over one or more network channels, illustrated as a network cloud 22. For example, in various embodiments, the network environment 2 may include, but is not limited to, a generative review aggregation computing device 4, a web server 6, a cloud-based engine 8 including one or more processing devices 10, a database 14, and/or one or more user computing devices 16, 18, 20 operatively coupled over the network 22. The generative review aggregation computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the generative review aggregation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the generative review aggregation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the generative review aggregation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the generation of aggregated reviews computing device 4, for example. The workstation(s) 12 may communicate with the generation of aggregated reviews computing device 4 over the communication network 22. The workstation(s) 12 may send data to, and receive data from, the generative review aggregation reviews computing device 4. For example, the workstation(s) 12 may transmit data related to tracked operations performed at the physical location 26 to the generative review aggregation computing device 4.

Although FIG. 1 illustrates three user computing devices 16, 18, 20, the network environment 2 may include any number of user computing devices 16, 18, 20. Similarly, the network environment 2 may include any number of the generative review aggregation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the generative review aggregation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the generation of aggregated reviews computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the generation of aggregated reviews computing device 4.

In some embodiments, the generative review aggregation computing device 4 may execute one or more models, processes, or algorithms, such as a machine learning model, deep learning model, statistical model, etc., to generate aggregated reviews. The generative review aggregation computing device 4 may transmit one or more generated aggregated reviews to the web server 6 over the communication network 22, and the web server 6 may display interface elements associated with the generation of aggregated reviews on the website to the user. For example, the web server 6 may display interface elements associated with the generation of aggregated reviews to the user on a homepage, a catalog webpage, an item webpage, a window or interface of a chatbot, a search results webpage, or a post-transaction webpage of the website (e.g., as the user browses those respective webpages).

In some embodiments, the web server 6 transmits a generative review aggregation request to the generative review aggregation computing device 4. The generative review aggregation request may be a user viewing an item object page and looking through one or more reviews on the item object page.

In some embodiments, a user submits a query on a website hosted by the web server 6. The web server 6 may obtain one or more items responsive to a query and one or more associated reviews and send an aggregated review request to the generative review aggregation computing device 4. In response to receiving the aggregated review request, the generative review aggregation computing device 4 may execute one or more processes to determine the generation of aggregated reviews and transmit the results including the generation of aggregated reviews to the web server 6 to be displayed to the user. For example, a user browsing a catalog of an e-commerce site may interact with an object item including a plurality of customer reviews. Thus the generative review aggregation device 4 may generate a summary of the plurality of customer reviews.

The generative review aggregation computing device 4 is further operable to communicate with the database 14 over the communication network 22. For example, the generative review aggregation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the generative review aggregation computing device 4, in some embodiments, the database 14 may be a local storage device, such as a hard drive, a non-volatile memory, or a USB stick. The generative review aggregation computing device 4 may store interaction data received from the web server 6 in the database 14. The generative review aggregation computing device 4 may also receive from the web server 6 user session data identifying events associated with browsing sessions, and may store the user session data in the database 14.

In some embodiments, the generative review aggregation computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The generative review aggregation computing device 4 and/or one or more of the processing devices 10 may train one or more models based on corresponding training data. The generative review aggregation computing device 4 may store the models in a database, such as in the database 14 (e.g., a cloud storage database).

The models, when executed by the generative review aggregation computing device 4, allow the generative review aggregation computing device 4 to generate aggregated reviews. For example, the generative review aggregation computing device 4 may obtain one or more models from the database 14. The generative review aggregation computing device 4 may then receive, in real-time from the web server 6, one or more reviews. In response to receiving the one or more reviews, the generative review aggregation computing device 4 may execute one or more models to generate and/or iteratively modify aggregated reviews.

In some embodiments, the generative review aggregation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the generative review aggregation computing device 4 may generate one or more aggregated reviews.

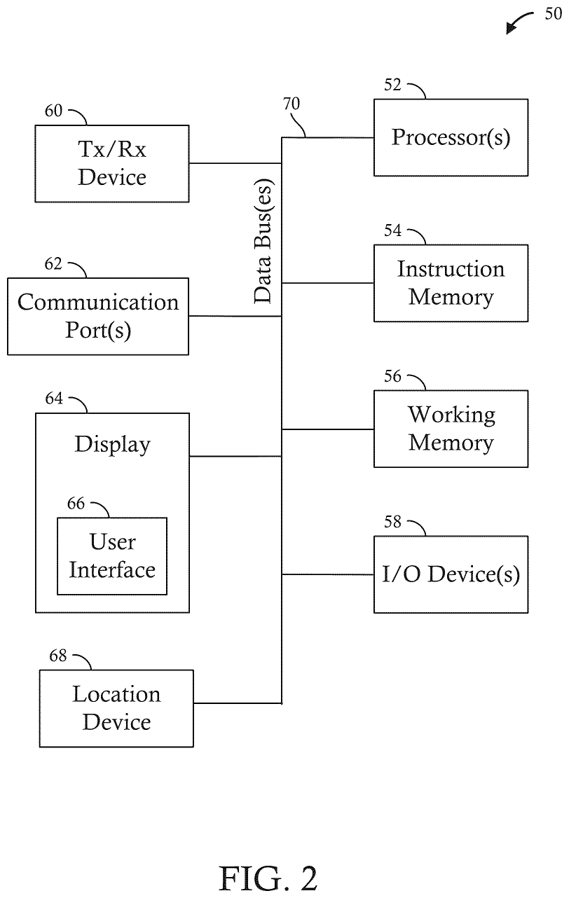

FIG. 2 illustrates a block diagram of a computing device 50, in accordance with some embodiments. In some embodiments, each of the generative review aggregation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating aggregated reviews, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with one or more generated aggregated reviews. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

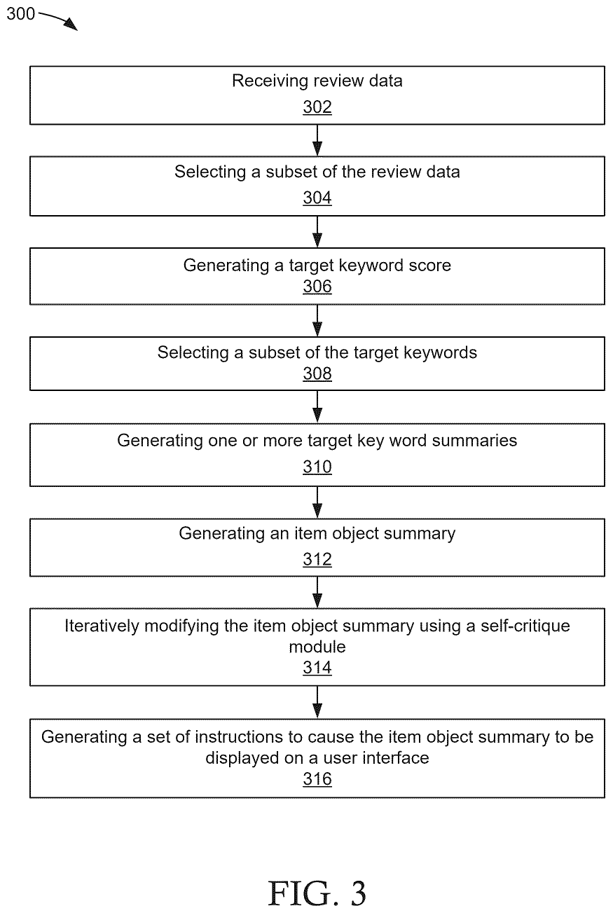

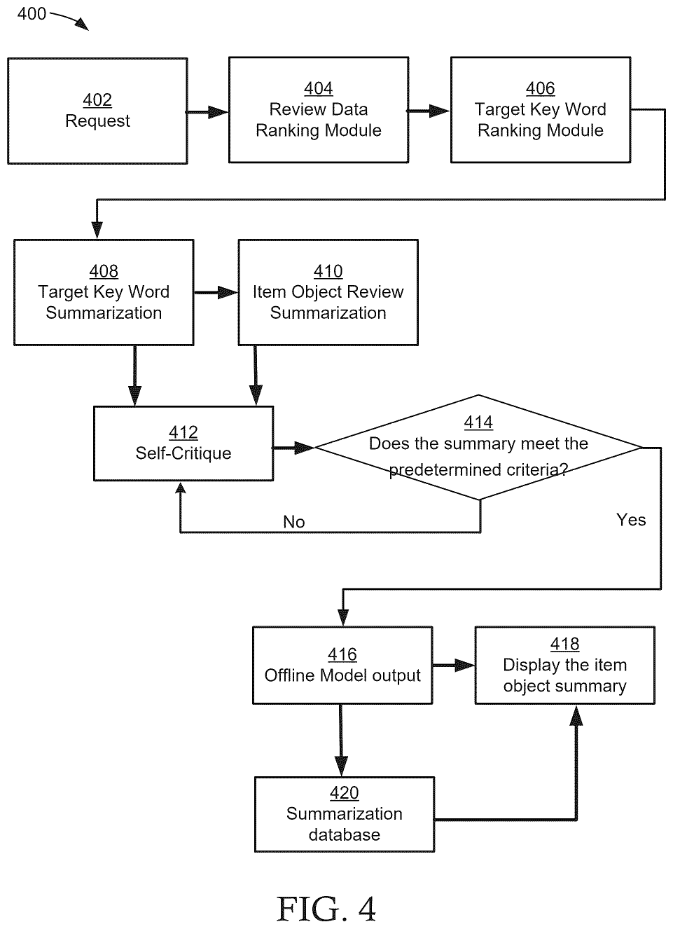

FIG. 3 is a flowchart illustrating a summary generation method 300 configured to generate one or more target keyword summaries and/or an item object review summary, in accordance with some embodiments. FIG. 4 is a process flow 400 illustrating various steps of the summary generation method 300, in accordance with some embodiments. Although embodiments are discussed herein including application of certain steps and/or processes, it will be appreciated that various elements of the summary generation method 300 may be performed in various orders and/or performed by additional and/or alternative processes or system elements as those disclosed herein. The summary generation method 300 may be implemented by any suitable system, device, etc., such as, for example, the generative aggregation computing device 4.

At step 302, review data associated with an item object is obtained. For example, the review data may be received from a data source, generated by a system executing the summary generation method 300, and/or otherwise obtained. In some embodiments, the review data includes at least one or more text-based elements, such as textual reviews for the corresponding item object (e.g., a product offered on an ecommerce interface) by at least one or more users and stored in a database. In some embodiments, in response to receiving a request 402, the review data is retrieved from a database. The review data may include one or more review features including one or more target keywords, which may be stored in conjunction with the review data in the database. The request 402 may be generated in response to a user requesting and/or visiting a landing page associated with the item object. The one or more target keywords may include words associated with specific features of an item object. For example, in a review written about a television, an example of a target keyword may be “resolution,” as another user purchasing a television may want to know if the television has subjectively good resolution. In some embodiments, the database includes at least one or more item objects representative of products in an ecommerce catalogue.

At step 304, a first subset of the review data is selected based on a first selection criteria. The first selection criteria may be contained in the review data ranking module 404, which ranks the review data based upon the first selection criteria in order to select more useful, e.g., higher quality, reviews. The first selection criteria includes factors designed to select higher quality reviews. Example factors used to select a higher quality subset of the review data can include, but are not limited to, authenticity, relevance, and helpfulness. For example, to support authenticity, the first selection criteria includes reviews written by users that are verified purchasers of the item objects the reviews is associated with. In another example, reviews written more recently may be more relevant as they may reflect the current state of the product/service and account for updates or changes that may have been implemented over time. In some embodiments, the review data includes additional data that indicates whether or not each respective review has been tagged as helpful by another user evaluating the review. Review data that has been tagged as helpful by one or more other users (e.g., through a thumbs up or down on a user interface) may indicate that a community of users associated with the platform hosting the review has indicated that the information provided in the review was useful and relevant.

At step 306, a target keyword score is generated by a target keyword ranking module 406 for each respective keyword of the one or more keywords based on a polarity of the keywords. Each respective target keyword identified in the review data is given a target keyword score by the target keyword ranking module 406. Each respective target keyword score is based on, for example, one or more variables including the number of reviews that mentions each respective target keyword and an average sentiment score of the respective target keyword. The sentiment of the respective target keyword may be determined by assessing positive words, e.g., words indicating the item object has good features in the opinion of the reviewer such as the set up time for the item object was easier and faster than the reviewer anticipated and negative words, e.g., words indicating the item has features that were unsatisfactory to the reviewer such as broken parts when the item object arrived, surrounding the respective target keyword in one or more reviews. For example, when reviews include at least one or more words with negative connotations surrounding a respective keyword, then the respective keyword will receive a lower sentiment score. In contrast, when a respective keyword has one or more positive words with positive connotations surrounding it, the respective keyword will receive a higher sentiment score. The polarity of the target keywords includes respective keywords with the highest or lowest target keyword scores. In some embodiments, the target keyword ranking module 406 uses Bayesian averaging to calculate a weighted importance for each respective target keyword to balance the sentiment intensity with the mention frequency. In some embodiments, each target keyword is given an initial ranking based on the average sentiment score. Subsequently, the target keywords are re-ranked after the target keyword ranking module 406 incorporates the mention frequency of each target keyword into the revised target keyword ranking score. The revised target keyword ranking scores for each target keyword are stored in a revised target keyword ranking scores dataset.

At step 308, a second subset of the target keywords are selected. Ins some embodiments, each keyword in the second subset of target keywords has a respective target keyword score within a predetermined range of the target keyword scores. For example, a revised target keyword ranking score dataset may include one or more highest ranked and/or one or more lowest ranked target keyword ranking scores. In some embodiments, the predetermined range of target keyword scores selected is a percentage (e.g., top 10%) of the highest and a percentage (e.g., bottom 10%) of the lowest ranked target keywords. For example, if an item object has six identified target keywords that are ranked from 1-6 (1 being the highest and 6 being the lowest) and the predetermined range includes the top 20% and the bottom 20% of the ranked target keywords, then the second subset of the target keywords will include the top two highest ranked target keywords and the bottom two lowest ranked target keywords. In some embodiments, the predetermined range of the target keyword scores is a predetermined integer (e.g., top/bottom 2, 3, 4 etc.).

At step 310, one or more target keyword summaries are generated for each respective target keyword of the selected subset of the target keywords. In some embodiments, a target keyword summarization model 408 (e.g., one or more large language models) is used to generate one or more target keyword summaries that reflect a consensus of the information contained in the review data. In some embodiments, the target keyword summaries are configured to provide a clear and informative summary targeting important features of an item object. For example, if four target keywords are selected for the subset of the target keywords, then four distinct target keyword summaries are generated. Furthermore, the target keyword summaries may include one or more statements with a positive or negative view regarding the features related to the target keyword. For example, continuing the example from above where the target keyword “resolution” is selected to discuss a television review, in accordance with a determination that the words used to describe the resolution of the television have a positive connotation, a summarized review of the positive features of the resolution may be included in the target keyword summaries. In another example, if the target keyword “set up” is selected and has words describing it that are all negative, then the target keyword summary will include a negative summary of the set-up of the television.

In some embodiments, the target keyword summarization model 408 includes a diversity model which ensures that each respective target keyword summary includes a diverse set of keywords (e.g., excluding several words that are similar to each other). In some embodiments, keywords are clustered based on the semantic similarity of keyword names. A selection algorithm then selects diverse keywords from different clusters ensuring diversity while maintaining the priority to the ranking from the previous module. In some embodiments, one or more reviews will use similar keywords to address the same feature of a product. Thus, the diversity model ensures that similar keywords are clustered together and considered as one keyword instead of several similar keywords.

At step 312, an item object summary is generated. In some embodiments, the item object summary is generated based on the one or more target keyword summaries using an item object review summarization model 410. For example, the item object review summarization model 410 can include a large language model. The generated item object summary includes review features from the one or more target keyword summaries. For example continuing the example discussed at step 310, the item object summary for the television can include the positive features discussed in the reviews about the resolution and also include the negative features discussed about the set-up for the television. In some embodiments, the item object summaries incorporate all of the features discussed in the target keyword summaries.

At step 314, the item object summary is iteratively modified by the self-critique module 412. In some embodiments, the self-critique module iteratively modifies (e.g., corrects) the item object summary based on at least one or more characteristics of the item object summary. Additionally, in some embodiments, the self-critique module is configured to evaluate the at least one or more characteristics of the item object summary and adjust the item object summary in accordance with a determination that at least one or more characteristics of the item object summary does not meet a first criteria. In other words, the self-critique iteratively modifies the item object summary by correcting any identified issues. In some embodiments, a perceived quality of the item object summary is enhanced by the iterative process. The modified item object summary may be evaluated again to determine whether the modified item object summary passes a predetermined criteria 414 (e.g., publishing criteria). When the modified item object summary does not meet the predetermined criteria, then the self-critiquing module 412 continues to iteratively modify the item object review until it meets the predetermined criteria. In some embodiments, when the self-critique module adjusts (e.g., modifies) the item object summary, the self-critique module adjusts the grammar, sentence structure, and/or includes/excludes information with the goal to increase the accuracy, relevance, and quality of the item object summary.

In some embodiments, the self-critique module 412 evaluates the item object summary based on one or more characteristics of the item object summary including, for example, at least one of coherence of the summary, authenticity, redundancy, relevance, fluency, contradiction, etc. For example, to evaluate for coherence and fluency the self-critiquing module evaluates the summary review to ensure it is intelligible (e.g., intelligible, articulate, reasoned, etc.) to a user reading it and at a reading level that accurately reflects a reasonable fluency (e.g., an 8^{th} grade reading level). Furthermore, to evaluate for redundancy, the self-critiquing module evaluates the item object review summary to ensure the same information is not repeated multiple times (e.g., containing redundant information) or to ensure the item object review does not contain contradicting information (e.g., includes positive and negative review features for the same target keyword). In another example, the self-critique module evaluates for relevance to ensure that a reader reading the item object summary would find the information provided in the review useful to related to the item object. For example, in the example using the television, it's likely not relevant if review included information on setting up a projector (e.g., not the television that the review is about).

In some embodiments, as illustrated in FIG. 4, after the one or more target keyword summaries are generated by the target keyword summarization model 408, the self-critique module 412 evaluates each of the one or more target keyword summaries based on one or more characteristics of the one or more target keyword summaries including, for example, at least one of coherence of the summary, authenticity, redundancy, relevance, fluency, contradiction, etc. The self-critique module 412 evaluates and iteratively modifies each of the one or more target keyword summaries in the same and/or similar way as the self-critique module 412 evaluates an iteratively modifies the item object summaries. For example, the self-critique module 412 may ensure there is no repeated information, no contradicting information, the target keyword summaries arc intelligible, etc.

In some embodiments, the self-critique module 412 includes one or more large language models. Examples of one or more large language models that could be used are Llama13B, GPT-3.5, GPT-4, and/or Mixtral 8x7B. These examples are non-limiting and any large language model can be used. After passing the predetermined criteria and the item object review summary is ready for publishing, the item object summary is put into the offline model output 416. From the offline model output, the one or more keyword summaries and item object summaries may be stored in the summarization database 420 and updated when the one or more keyword summaries and item object summaries are updated.

At step 316, a set of instructions are generated to cause the item object summary to be displayed on user interface 418. In some embodiments, in accordance with a determination that the item object summary is ready for presentation to a user, instructions are generated such that if a user is viewing a landing page for the item object, the item object summary is displayed on the user interface for the user.

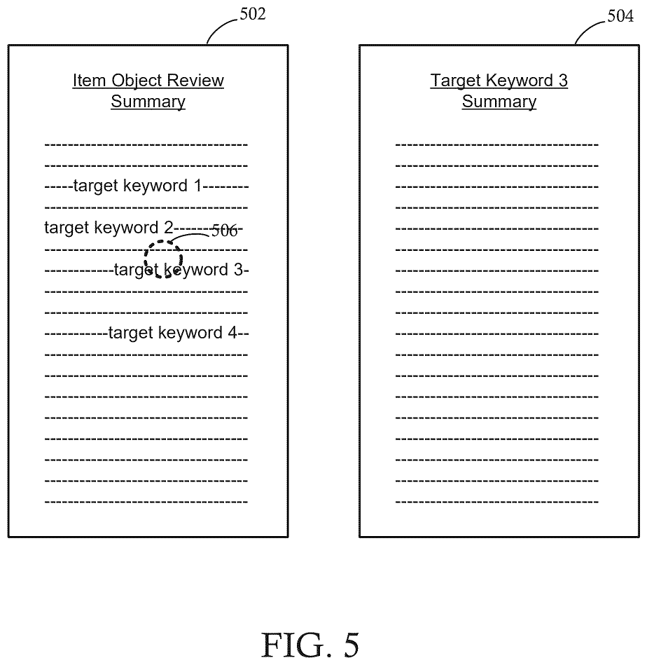

FIG. 5 illustrates an example of an item object review summary and a target keyword summary at a user interface, in some embodiments. As described with respect to FIG. 3, at least one or more target keyword summaries (e.g., displayed on target keyword 3 summary user interface 504) are generated and subsequently used to generate an item object review summary user interface 502. FIG. 5 further illustrates one or more target keywords identified in the item object review summary user interface 502 which include both positive and negative attributes about the item object. In accordance with a determination that a selection 506 is made on the item object review summary user interface 502 over the “target keyword 3” user interface element, the target keyword 3 summary user interface 504 appears on the user interface such that the user view a more in depth explanation of the details related to target keyword 3. In some embodiments, the item object review summary and the target keyword 3 summary are stored in the summarization database 420 before being presented at the item object review summary user interface 502 and/or the target keyword 3 summary user interface 504.

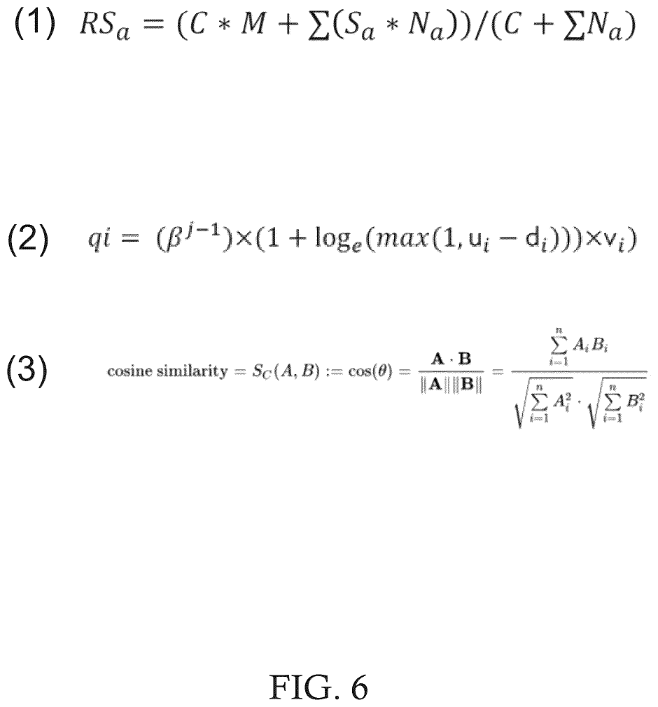

FIG. 6 illustrates one or more equations used by one or more of the modules, in some embodiments. Equation (1) is a used to in the target keyword ranking module 406 as described with respect to step 306. Equation (1) is a mathematical formulation for the Bayesian enhanced weighed target keyword importance score. The Bayesian average score (e.g., RSₐ) for target keyword a is calculated by taking the sum of the of the product of the sentiment score (e.g., Sa) and the number of mentions (e.g., the number of times the target keyword is used in the review) for each review mentioning target keyword a. The sum of Na is the total number of mentions for target keyword a.

Equation (2) is used in the review data ranking module 404 as described with respect to step 304. Equation (2) is a mathematical formula configured to determine the quality of a review contained in the review data. In some embodiments, qi indicates the computed quality of the review/which is function of the recency score, the feedback score, and whether or not the review of the item object is a verified purchase. β^{(j-1)} is the recency score which factors in how recent the review was written. (1+logₑ(max(1, uᵢ−−dᵢ))) is the calculated feedback score which includes the verified purchase score vᵢ, the total downvotes recorded for review i, uᵢ, the total upvotes recorded for review i, dᵢ, the decay rate used for recency, β, and j which is the decay step value computed based on review submission time.

In some embodiments, equation (3) is used in the target keyword ranking module 406 to select a diverse set of keywords. Keywords clustered based on the semantic similarity of keywords. For semantic similarity, “cosine similarity” between embeddings generated form a transformer based embedding model. “A” and “B” are the embeddings for the keywords. A selection algorithm then selects diverse aspects from different clusters ensuring diversity while maintaining the priority to the ranking from the previous module.

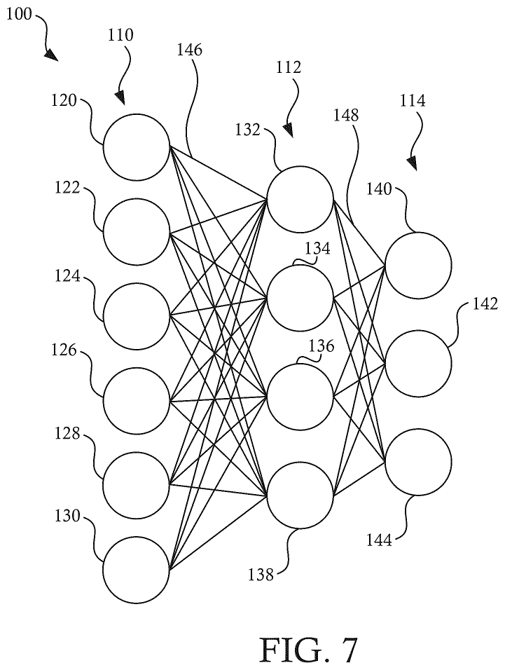

FIG. 7 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 7 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here,

$${x}_{j}^{( n )}$$

denotes the value of the 1-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined for the weight

$${w}_{i , j}^{( m , n + 1 )} .$$

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${w}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers

$${δ}_{j}^{( n )}$$

may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{j}^{( n )} \cdot {w}_{i , j}^{( n )} )$$

based on

$${δ}_{j}^{( n + 1 )} ,$$

if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and

$${y}_{j}^{( n + 1 )}$$

is the comparison training value for the j-th node of the output layer 114.

In some embodiments, the neural network 100 is configured, or trained, to generate at least one or more aggregated reviews.

In some embodiments, a transformer, e.g., a deep learning architecture based on a multi-head attention mechanism, is used as the basis of and/or to train the one or more models including a machine learning model, deep learning model, statistical model, etc., to generate aggregated reviews. Transformers convert text into numerical tokens and contextualize them using parallel multi-head attention. In some embodiments, a pre-trained system, such as a generative pre-trained transformers (GPTs) and/or a Bidirectional Encoder Representation (BERT) are utilized, although it will be appreciated that any suitable transformer architecture may be implemented.

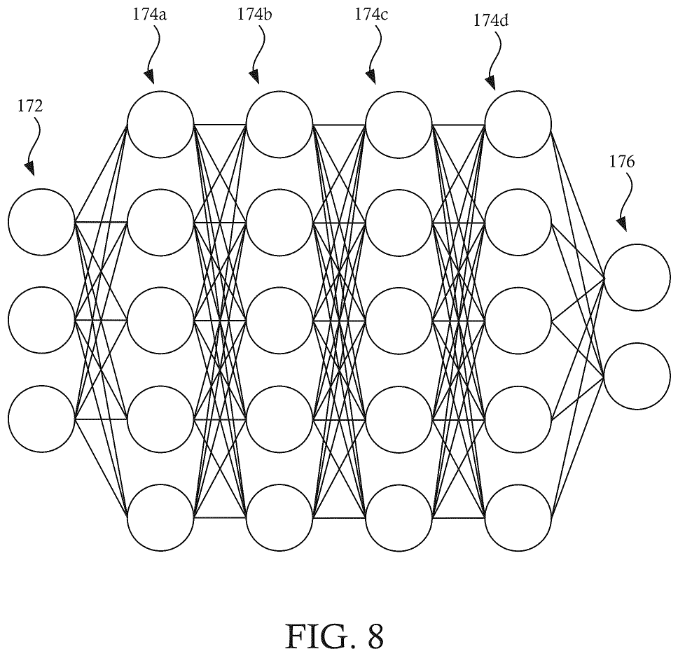

FIG. 8 illustrates a deep neural network (DNN) 170, in accordance with some embodiments. The DNN 170 is an artificial neural network, such as the neural network 100 illustrated in conjunction with FIG. 7, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( ⋯ ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + ⋯ + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

The user features may include user preference data for a user based on attributes associated with that user. For example, the user preference data may identify and characterize attributes associated with a user during a browsing session of a website. In some examples, more than one attribute per attribute category (e.g., brand, type, description) may be identified. When generating user preference data for a user, the generation of aggregated reviews computing device 4 may determine, for each attribute category, an attribute that is identified most often (e.g., a majority attribute). The attribute defined most often in each attribute category is stored as part of the corresponding user preference data. In some examples, a percentage score is generated for each attribute within an attribute category, and the percentage score is stored as part of the user preference data. The percentage score is based on a number of times a particular attribute is identified in a corresponding attribute category with respect to the number of times any attribute is identified in that attribute category. In some examples, the generation of aggregated reviews computing device 4 stores the user preference data in the database 14.

Identification of high quality reviews associated with item objects in a catalogue can be burdensome and time consuming for users, especially if there are thousands of them. Typically, a user may locate information regarding reviews by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding high quality reviews.

Systems including trained machine learning model, deep learning model, statistical model, etc., to generate aggregated reviews, as disclosed herein, significantly reduce this problem, allowing users to locate high quality reviews with fewer, or in some case no, active steps. For example, in some embodiments described herein, when a user is presented with an item object review summary, each interface element includes, or is in the form of, a link to an interface page for target keyword summaries. Each recommendation thus serves as a programmatically selected navigational shortcut to an interface page, allowing a user to bypass the navigational structure of the browse tree. Beneficially, programmatically identifying high quality review summaries and presenting a user with navigations shortcuts to these tasks may improve the speed of the user's navigation through an electronic interface, rather than requiring the user to page through multiple other pages in order to locate the high quality review summaries via the browse tree or via a search function. This may be particularly beneficial for computing devices with small screens, where fewer interface elements are displayed to a user at a time and thus navigation of larger volumes of data is more difficult.

It will be appreciated that generating aggregated review summaries as disclosed herein, particularly on large datasets intended to be used to generate trained models used in the disclosed embodiments, is only possible with the aid of computer-assisted machine-learning algorithms and techniques, such as self-critique module 412. In some embodiments, machine learning processes including self-critique module 412 are used to perform operations that cannot practically be performed by a human, either mentally or with assistance, such as the generation of aggregated reviews. It will be appreciated that a variety of machine learning techniques can be used alone or in combination to generate self-critique module 412.

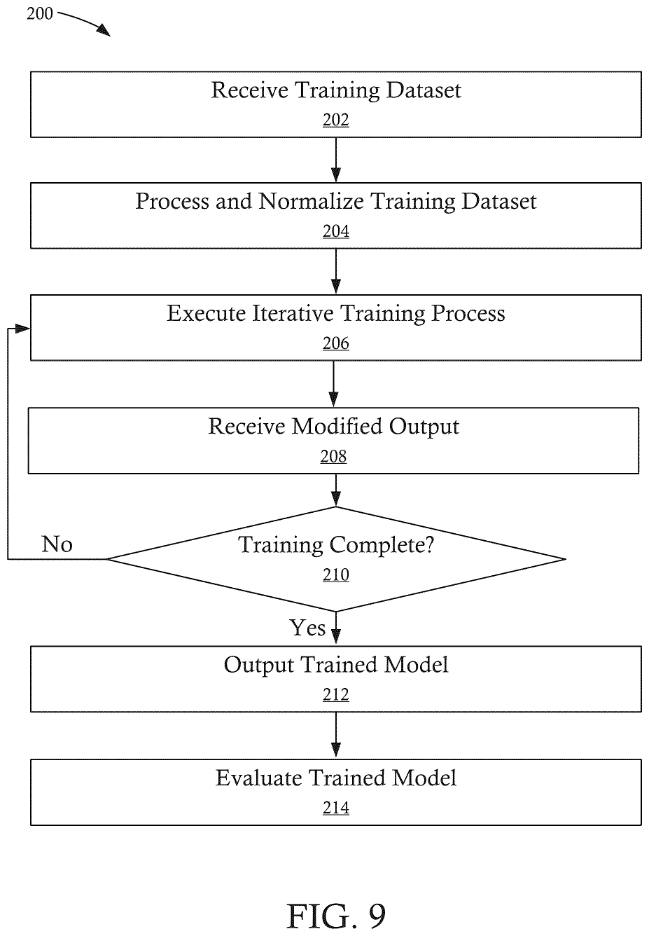

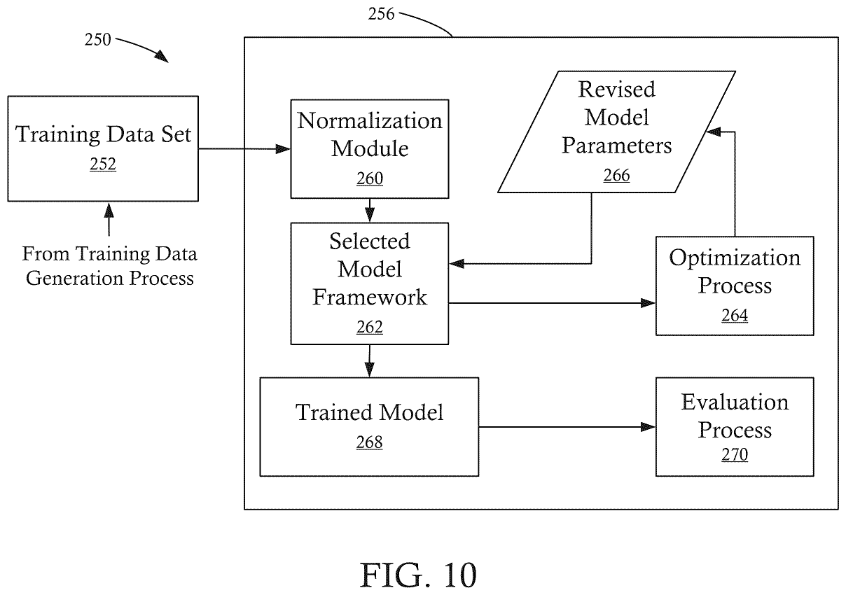

In some embodiments, a method for generating aggregated reviews can include and/or implement one or more trained models, such as a trained self-critique model. In some embodiments, one or more trained models can be generated using an iterative training process based on a training dataset. FIG. 9 illustrates a method 200 for generating a trained model, such as a trained optimization model, in accordance with some embodiments. FIG. 10 is a process flow 250 illustrating various steps of the method 200 of generating a trained model 256, in accordance with some embodiments. At step 202, a training dataset 252 is received by a system, such as a processing device 10. In some embodiments, the training dataset 252 includes pre-generated aggregated reviews.

At optional step 204, the received training dataset 252 is processed and/or normalized by a normalization module 260. For example, in some embodiments, the training dataset 252 can be augmented by imputing or estimating missing values of one or more features associated with target keyword summaries and/or item object review summaries. In some embodiments, processing of the received training dataset 252 includes outlier detection configured to remove data likely to skew training of a the self-critique model. In some embodiments, processing of the received training dataset 252 includes removing features that have limited value with respect to training of the self-critique model.

At step 206, an iterative training process is executed to train a selected model framework 262. When the executive iterative training process 206 is complete, the modified output is received at step 208. The selected model framework 262 can include an untrained (e.g., base) machine learning model, such as one version of the self-critique model and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. In some embodiments, the cost value is related to producing high quality item object and target keyword review summaries.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 210, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 212, a trained model 268, such as a trained self-critique model, is output and provided for use in an aggregated summary generation method, such as the aggregated summary generation method 300 discussed above with respect to FIGS. 3-4. At optional step 214, a trained model 268 can be evaluated by an evaluation process 270. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory having instructions stored thereon; and
a processor configured to read the instructions to:
receive review data associated with an item object in a database, wherein the review data includes one or more review features including one or more target keywords;
select a subset of the review data based on a first selection criteria configured to select a first subset of the review data;
generate a target keyword score for each respective target keyword of the one or more target keywords based on a polarity of the target keywords;
select a subset of the target keywords each having a respective target keyword score based on a predetermined range of the target keyword scores;
generate one or more target keyword summaries for each respective target keyword of the selected subset of the target keywords;
generate an item object summary based on the one or more target keyword summaries using a summarization model;
iteratively modify the item object summary using a self-critique module based on at least one or more characteristics of the item object summary, wherein:
the self-critique module includes one or more large language models configured to evaluate the at least one or more characteristics of the item object summary and adjust the item object summary in accordance with a determination that the at least one or more characteristics of the item object summary does not meet a first criteria; and
generate a set of instructions to cause the item object summary to be displayed on a user interface.

2. The system of claim 1, wherein the processor is configured to read the instructions to generate the target keyword score based a number of reviews that include each respective target keyword and a sentiment score of the respective target keyword.

3. The system of claim 2, wherein the processor is configured to read the instructions to generate the sentiment score of the respective target keyword based on a first number of words of one or more reviews that surround the respective target keyword with a positive connotation, and a second number of words of the one or more reviews that surround the respective target keyword with a negative connotation.

4. The system of claim 1, wherein the predetermined range of the target keyword scores comprises a first number of the highest target keyword scores and a second number of the lowest target keyword scores.

5. The system of claim 1, wherein the processor is configured to read the instructions to input each respective target keyword of the selected subset of the target keywords to a large language model to generate the one or more target keyword summaries for each respective target keyword.

6. The system of claim 1, wherein the processor is configured to:
read the instructions to determine, based on the use of the self-critique module, that the at least one or more characteristics of the item object summary do not meet the first criteria, wherein the first criteria includes at least one of incorrect grammar, incorrect sentence structure, and redundance; and
adjust the item object summary to correct the at least one of incorrect grammar, incorrect sentence structure, and redundancy.

7. The system of claim 1, wherein the processor is configured to read the instructions to execute the self-critique module and, in response, adjust the item object summary.

8. The system of claim 7, wherein the processor is configured to read the instructions to:
receive a training data set;
input the training data set into an untrained self-critique module and, in response, adjust one or more parameters of the untrained self-critique module;
determine that the untrained self-critique module is trained based on the adjusted one or more parameters; and
store the adjusted one or more parameters in a database, wherein the adjusted one or more parameters characterize the self-critique module.

9. The system of claim 1, wherein the processor is configured to read the instructions to display the user interface on a landing page associated with the item object that a user is viewing.

10. A computer implemented method, comprising:
receiving review data associated with an item object in a database, wherein the review data includes one or more review features including one or more target keywords;
selecting a subset of the review data based on a first selection criteria configured to select a first subset of the review data;
generating a target keyword score for each respective target keyword of the one or more target keywords based on a polarity of the target keywords;
selecting a subset of the target keywords each having a respective target keyword score based on a predetermined range of the target keyword scores;
generating one or more target keyword summaries for each respective target keyword of the selected subset of the target keywords;
generating an item object summary based on the one or more target keyword summaries using a summarization model;
iteratively modifying the item object summary using a self-critique module based on at least one or more characteristics of the item object summary, wherein:
the self-critique module includes one or more large language models configured to evaluate the at least one or more characteristics of the item object summary and adjust the item object summary in accordance with a determination that the at least one or more characteristics of the item object summary does not meet a first criteria; and
generating a set of instructions to cause the item object summary to be displayed on a user interface.

11. The method of claim 10, comprising generating the target keyword score based a number of reviews that include each respective target keyword and a sentiment score of the respective target keyword.

12. The method of claim 11, comprising generating the sentiment score of the respective target keyword based on a first number of words of one or more reviews that surround the respective target keyword with a positive connotation, and a second number of words of the one or more reviews that surround the respective target keyword with a negative connotation.

13. The method of claim 10, wherein the predetermined range of the target keyword scores comprises a first number of the highest target keyword scores and a second number of the lowest target keyword scores.

14. The method of claim 10, comprising inputting each respective target keyword of the selected subset of the target keywords to a large language model to generate the one or more target keyword summaries for each respective target keyword.

15. The method of claim 10, comprising:
determining, based on the use of the self-critique module, that the at least one or more characteristics of the item object summary do not meet the first criteria, wherein the first criteria includes at least one of incorrect grammar, incorrect sentence structure, and redundance; and
adjusting the item object summary to correct the at least one of incorrect grammar, incorrect sentence structure, and redundancy.

16. A non-transitory computer-readable storage medium comprising executable instructions that, when executed by one or more processors of a computing device, cause the one or more processors to:
receive review data associated with an item object in a database, wherein the review data includes one or more review features including one or more target keywords;
select a subset of the review data based on a first selection criteria configured to select a first subset of the review data;
generate a target keyword score for each respective target keyword of the one or more target keywords based on a polarity of the target keywords;
select a subset of the target keywords each having a respective target keyword score based on a predetermined range of the target keyword scores;
generate one or more target keyword summaries for each respective target keyword of the selected subset of the target keywords;
generate an item object summary based on the one or more target keyword summaries using a summarization model;
iteratively modify the item object summary using a self-critique module based on at least one or more characteristics of the item object summary, wherein:
the self-critique module includes one or more large language models configured to evaluate the at least one or more characteristics of the item object summary and adjust the item object summary in accordance with a determination that the at least one or more characteristics of the item object summary does not meet a first criteria; and
generate a set of instructions to cause the item object summary to be displayed on a user interface.

17. The non-transitory computer-readable storage medium of claim 16 comprising executable instructions that, when executed by the one or more processors of the computing device, cause the one or more processors to generate the target keyword score based a number of reviews that include each respective target keyword and a sentiment score of the respective target keyword.

18. The non-transitory computer-readable storage medium of claim 17 comprising executable instructions that, when executed by the one or more processors of the computing device, cause the one or more processors to generate the sentiment score of the respective target keyword based on a first number of words of one or more reviews that surround the respective target keyword with a positive connotation, and a second number of words of the one or more reviews that surround the respective target keyword with a negative connotation.

19. The non-transitory computer-readable storage medium of claim 16, wherein the predetermined range of the target keyword scores comprises a first number of the highest target keyword scores and a second number of the lowest target keyword scores.

20. The non-transitory computer-readable storage medium of claim 16 comprising executable instructions that, when executed by the one or more processors of the computing device, cause the one or more processors to input each respective target keyword of the selected subset of the target keywords to a large language model to generate the one or more target keyword summaries for each respective target keyword.
